(19) United States
(12) Patent Application Publication
(10) Pub. No.: US 2026/0252949 A1
(43) Pub. Date: Aug. 27, 2026

(54) ENHANCED DATA SAMPLING FOR EXPERT TASKS DURING MODEL ADAPTATION AND EVALUATION

(71) Applicant: Adobe Inc., San Jose, CA (US)

(72) Inventors: Adit JAIN, Ithica, NY (US); Sunav Choudhary, San Jose, CA (US); Soumyabrata Pal, Bengaluru (IN); Ramasuri Narayanam, Bengaluru (IN); Harshita Chopra, Delhi (IN)

(21) Appl. No.: 19/062,255

(22) Filed: Feb. 25, 2025

(51) Int. Cl. G06N 20/00; G06F 9/54; G06N 5/022

(52) U.S. Cl. CPC G06N 20/00; G06F 9/544; G06N 5/022

(57) ABSTRACT

Some aspects relate to technologies for enhanced data sampling for expert tasks during model adaptation and/or evaluation. In accordance with some aspects, a first subset of datapoints is sampled from a dataset and provided to an expert for an expert task for adapting or evaluating a target model. Task difficulty scores are obtained for the first subset of datapoints based on a difficulty in performing the expert task for each datapoint. A difficulty prediction model is trained using the first subset of datapoints and their corresponding task difficulty scores. Using the difficulty prediction model, task difficulty scores are generated for other datapoints from the dataset not in the first subset of datapoints. A second subset of datapoints is sampled from the other datapoints based on the task difficulty scores for the other datapoints. The second subset of datapoints are provided to the expert for performance of the expert task.

### BACKGROUND

Model adaptation is a fundamental process in machine learning, involving the use of algorithms to learn patterns from data. Adaption often involves adjusting a model's behavior based on new data. Supervised learning is one form of model adaptation that employs the use of labeled data, where each datapoint is paired with an annotation or label. This can include using labeled data to train a model, where parameters of the model are adjusted during training. In-context learning is another supervised learning approach in which labeled examples are provided to a model to guide the model without parameter updates. Model evaluation is also typically performed after model adaptation to assess the model's performance, for instance, to determine the model's accuracy, generalization ability, and effectiveness.

Human experts often perform different tasks to support the model adaptation and evaluation process. For instance, the creation of labeled datasets often involves human experts who provide the necessary annotations. These experts can be essential for tasks that require specialized knowledge, such as labeling medical images or annotating legal documents. For example, in the field of radiology, a radiologist's expertise is required to accurately label portions of images that indicate the presence of cancer. This expertise ensures that the labeled data is of high quality, which is critical for training models that can make accurate predictions. Experts often also play a role in evaluating model output during model adaptation. Their evaluations help identify errors and areas where the model needs improvement. This iterative process of model adaption and evaluation, guided by expert feedback, is important for developing robust and reliable machine learning models.

### SUMMARY

Some aspects of the present technology relate to, among other things, enhanced data sampling techniques for expert tasks during model adaptation and/or evaluation of machine learning models. In accordance with some aspects, given a dataset of datapoints for which an expert task is to be performed to provide expert data for model adaptation or evaluation, a first subset of datapoints are sampled from the dataset. The first subset of datapoints is provided to an expert for the expert to perform an expert task to provide expert data, such as a label or evaluation data, for each datapoint in the first subset. Task difficulty scores are also obtained for each of these datapoints indicative of the difficulty in performing the expert task for each datapoint.

The first subset of datapoints and their corresponding task difficulty scores are used to train a difficulty prediction model. Once trained, the difficulty prediction model is used to determine task difficulty scores for other datapoints in the dataset not previously provided to the expert. Based on these task difficulty scores, a second subset of datapoints is selected for the expert task. The second set of datapoints are provided to the expert, and expert data for the datapoints is received from the expert. The expert data for both subsets of datapoints can then be employed for model adaptation and/or evaluation of a target machine learning model.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram showing an example process for facilitating an expert task on datapoints for model adaptation and/or evaluation in accordance with some implementations of the present disclosure;

FIG. 3 is a flow diagram showing a method for performing an exploration phase to obtain task difficulty scores for an exploration subset and employing the task difficulty scores to train a difficulty prediction model in accordance with some implementations of the present disclosure;

FIG. 4 is a flow diagram showing a method for using a trained difficulty prediction model to determine task difficulty scores for datapoints in a dataset and using the task difficulty scores to select a task subset of datapoints for an expert task in accordance with some implementations of the present disclosure; and

FIG. 5 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “dataset” refers to a collection of datapoints that are used for various tasks in machine learning, such as model adaptation and evaluation. The dataset serves as the foundational resource from which subsets of datapoints are sampled for specific expert tasks for the machine learning tasks, ensuring that a target machine learning model has access to diverse and representative data for training and/or evaluation purposes.

A “datapoint” is an individual unit of data within a dataset. Each datapoint within the dataset can contain different types of data, such as labeled or unlabeled data, input-output pairs, or other relevant information. In some cases, a datapoint can be represented as a vector or an array of features that capture specific attributes or characteristics of the datapoint. In the context of machine learning, each datapoint can be associated with a label or annotation provided by an expert, which can be used for model adaptation.

An “expert” is an individual with specialized knowledge or skills in a particular domain, who performs expert tasks such as annotation or evaluation of datapoints in a dataset. Experts provide high-quality labels or evaluations that are used for adapting and evaluating machine learning models. Expert expertise ensures that the data used for model adaptation and/or evaluation is accurate and reliable, leading to better model performance.

An “expert task” is a specific activity performed by an expert on a datapoint, such as annotation or evaluation. Expert tasks involve the expert providing “expert data”, such as labels, annotations, or assessments, that are used to adapt or evaluate a machine learning model. Expert tasks facilitate obtaining high-quality data, leveraging the expert's specialized knowledge to ensure accuracy and reliability.

As used herein, an “exploration subset” is a smaller, representative sample of datapoints selected from the larger dataset during an exploration phase in which the exploration subset is provided to an expert to perform an expert task. In some aspects, the exploration subset is chosen to ensure diversity and coverage of the dataset, allowing experts to perform tasks on these datapoints. A datapoint in an exploration subset is referred to herein as an “exploration datapoint”.

A “task difficulty score” is used herein to refer to a value that represents the level of difficulty for an expert to perform an expert task on an a datapoint. For the exploration subset, the task difficulty score can be assigned directly by the expert based on their subjective assessment or can be determined using a proxy measure, such as the amount of time taken to complete the expert task.

As used herein, a “difficulty prediction model” is a model designed to predict the difficulty of performing an expert task on a given datapoint. In some aspects, a difficulty prediction model is trained using an exploration subset of datapoints and their corresponding task difficulty scores. Once trained, the difficulty prediction model can be used to determine task difficulty scores for datapoints in a dataset not provided to an expert for an expert task.

The term “task subset” is used herein to refer to a collection of datapoints selected from a dataset based on task difficulty scores generated for datapoints in the dataset by a difficulty prediction model. A datapoint in a task subset is referred to herein as a “task datapoint.” In some aspects, datapoints with the highest task difficulty scores are selected for the task subset to provide datapoints that are challenging and informative for the expert task. The task subset is provided to an expert for an expert task, and expert data obtained from the expert task for the task subset can be used for adapting and/or evaluation a target machine learning model.

### Overview

Aspects of the technology described herein related to addressing a significant challenge in the field of machine learning, particularly in the context of model adaptation and evaluation. The core problem revolves around the scarcity of high-quality data, which is essential for training effective machine learning models. In many industrial applications, large datasets are either unavailable or insufficient due to the need for domain-specific expertise. Often, human experts are needed to provide the high-quality data. However, this presents a bottleneck, especially for complex tasks requiring certain expertise where only a limited number of experts may be available to perform the expert tasks. This is not only time-consuming, but costly as well. As a result, budgets are usually put in place to restrict the number of datapoints for which an expert task will be performed. If the datapoints are not carefully selected, the resulting model adaptation or evaluation will suffer.

In literature, there is no consensus on which datapoints are useful. Inspired by curriculum learning, at a high level, “difficult” and “diverse” data points that comprise of most information content and avoid redundancy should be selected. For instance, in the case of Support Vector Machines (SVMs), the datapoints closest to the decision boundary (datapoints “difficult” for a model) are sufficient to identify the decision boundary if labelled. The remaining datapoints are redundant for learning the SVM decision boundary.

However, the definition of “difficulty” of a datapoint is ambiguous in general. To know the difficult points for a given machine learning model, it must be trained well—which makes it challenging in cases where good-quality data is not available. Many efforts have been geared towards selecting datapoints with the highest uncertainty according to the model (some statistical loss or gradient norm), but such an approach fails entirely in the annotation-expensive regime due to high noise or mislabeling when annotated datapoints are very few. Furthermore, the data distribution of datasets is typically skewed towards easy datapoints, further making it challenging to identify truly difficult yet highly informative datapoints.

Aspects of the technology described herein address this problem in machine learning by providing enhanced data sampling techniques for expert tasks that identify datapoints from a dataset that are both diverse and difficult. In some aspect, the approach described herein operates in two phases. In the first phase, a small, diverse subset of datapoints is selected, and an expert provides both expert data (e.g., gold standard labels for unlabeled datapoints or evaluation data for input-output pairs). Additionally, task difficulty scores are obtained these datapoints, reflecting the difficulty of performing the expert task for each datapoint. The task difficulty scores can be explicitly assigned by the expert or determined using a proxy such as a time required for the expert to perform the expert task for each datapoint.

In the second phase, a difficulty prediction model is trained using the first subset of datapoints and their task difficulty scores. The task prediction model is then used to predict the difficulty of remaining datapoints in the dataset. A second subset comprising the most difficult and informative datapoints can be selected for the expert task based on the task difficulty scores, ensuring a balance between data diversity and difficulty. The expert data obtained from the expert for both subsets of datapoints can then be used for performing model adaptation or evaluation for a target machine learning model.

Aspects of the technology described herein provide a number of improvements over existing technologies. For instance, by obtaining difficulty feedback from experts in a principled manner, the technology described ensures that the selected datapoints are both representative and challenging, leading to more effective model training. This approach reduces the cost by focusing on the most informative datapoints, thereby improving the efficiency of the process. Additionally, the technology enhances the quality of the adaptation/evaluation data, leading to better model performance and generalization. Overall, this represents a significant advancement in the field of machine learning, addressing key challenges and providing a robust solution for obtaining high-quality data. Experiments comparing the performance of this sampling technique with conventional approaches has demonstrated the efficacy of this solution.

### Example System for Enhanced Data Sampling for Expert Tasks

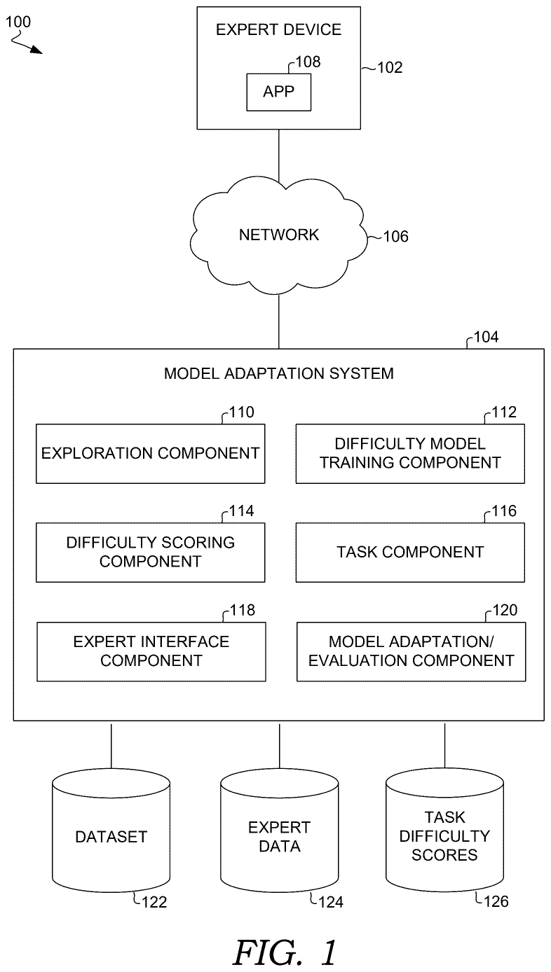

With reference now to the drawings, FIG. 1 is a block diagram illustrating an exemplary system 100 for enhanced data sampling for expert tasks for model adaptation or evaluation in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

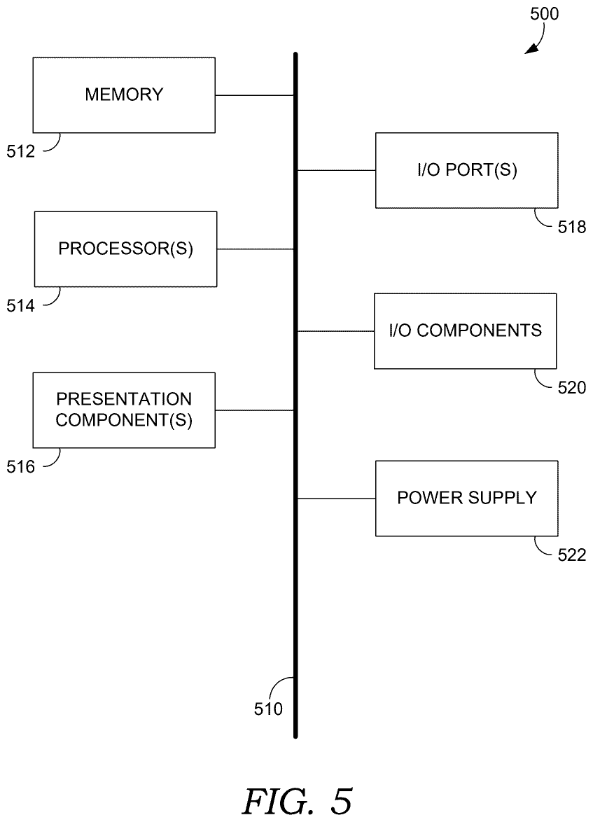

The system 100 is an example of a suitable architecture for implementing certain aspects of the present disclosure. Among other components not shown, the system 100 includes an expert device 102 and a model adaptation system 104. Each of the expert device 102 and the model adaptation system 104 shown in FIG. 1 can comprise one or more computer devices, such as the computing device 500 of FIG. 5, discussed below. As shown in FIG. 1, the expert device 102 and the model adaptation system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of expert devices and servers may be employed within the system 100 within the scope of the present technology. Each can comprise a single device or multiple devices cooperating in a distributed environment. For instance, the model adaptation system 104 could be provided by multiple server devices collectively providing the functionality of the model adaptation system 104 as described herein. Additionally, other components not shown may also be included within the network environment.

The expert device 102 can be a client device on the client-side of the system 100, while the model adaptation system 104 can be on the server-side of the system 100. The model adaptation system 104 can comprise server-side software designed to work in conjunction with client-side software on the expert device 102 so as to implement any combination of the features and functionalities discussed in the present disclosure. For instance, the expert device 102 can include an application 108 for interacting with the model adaptation system 104. The application 108 can be, for instance, a web browser or a dedicated application for providing functions, such as those described herein. This division of the system 100 is provided to illustrate one example of a suitable environment, and there is no requirement for each implementation that any combination of the expert device 102 and the model adaptation system 104 remain as separate entities. While the system 100 illustrates a configuration in a networked environment with a separate expert device and model adaptation system, it should be understood that other configurations can be employed in which aspects of the various components are combined. For instance, in some aspects, aspects of the model adaptation system 104 can be implemented at least in part by the expert device 102 and vice versa.

The expert device 102 may comprise any type of computing device capable of use by a user. For example, in one aspect, an expert device may be the type of computing device 500 described in relation to FIG. 5 herein. By way of example and not limitation, the expert device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user (e.g., an expert assigned to perform expert tasks) may be associated with the expert device 102 and may interact with the model adaptation system 104 via the expert device 102.

The model adaptation system 104 generally facilitates model adaptation and/or evaluation of a target machine learning model using datapoints from a dataset in a dataset datastore 122 and expert data provided from expert tasks. The type of datapoints in the dataset can depend on the type of expert task being performed. For instance, in the case of an annotation task, the dataset can comprise unlabeled datapoints for labelling/annotation. As another example, in the case of an evaluation task, the dataset can comprise input-output pairs, where each pair includes input to a target machine learning model and a corresponding output from the target machine learning model. As will be described in further detail below, the model adaptation system 104 provides for enhanced datapoint sampling for the expert tasks.

As shown in FIG. 1, the model adaptation system 104 includes: an exploration component 110; a difficulty model training component 112; a difficulty scoring component 114; a task component 116; an expert interface component 118; and a model adaptation/evaluation component 120. The components of the model adaptation system 104 may be in addition to other components that provide further additional functions beyond the features described herein. The model adaptation system 104 can be implemented using one or more server devices, one or more platforms with corresponding application programming interfaces, cloud infrastructure, and the like. While the model adaptation system 104 is shown separate from the expert device 102 in the configuration of FIG. 1, it should be understood that in other configurations, some of the functions and/or components of the model adaptation system 104 can be provided on the expert device 102 or another location not shown in FIG. 1. The components can be provided by a single entity or multiple entities.

In some aspects, the functions performed by components of the model adaptation system 104 are associated with one or more applications, services, or routines. In particular, such applications, services, or routines may operate on one or more expert devices, servers, may be distributed across one or more expert devices and servers, or be implemented in the cloud. Moreover, in some aspects, these components of the model adaptation system 104 may be distributed across a network, including one or more servers and client devices, in the cloud, and/or may reside on an expert device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The exploration component 110 of the model adaptation system 104 facilitates selection of datapoints from the dataset in the dataset datastore 122 for an exploration phase in which the selected datapoints are sent to an expert device, such as the expert device 102, for an expert task, such as annotation or evaluation. This initial subset of datapoints selected from the dataset are referred to herein as an exploration subset with each datapoint in the exploration subset being referred to herein as an exploration datapoint.

As part of the exploration phase, the expert performs the expert task, providing expert data for each datapoint, which can be stored in an expert data datastore 124. The expert data can comprise different data based on the expert task. For instance, in the context of an annotation task, the expert data can include a label for each unlabeled datapoint. In the context of an evaluation task, the expert data can comprise evaluation data based on the expert's evaluation of each input-output pair.

Difficulty scoring is also performed for the datapoints in the exploration subset, reflecting the difficulty of performing the expert task for each exploration datapoint. In some instances, the expert performing the task assigns a task difficulty score for each exploration datapoint. In instances in which the expert does not explicitly assign a task difficulty score to exploration datapoints, a proxy can be used to determine the task difficulty scores. For instance, an amount of time for the expert to complete the expert task for an exploration datapoint could be used to generate a task difficulty score for that datapoint. Task difficulty scores for the explorations datapoints can be stored in a task difficulty scores datastore 126. While FIG. 1 shows a separate dataset datastore 122, expert data datastore 124, and task difficulty scores datastore 126, it should be understood that the any number of datastores can be employed to store the datapoints expert data, and task difficulty scores.

The number of datapoints selected for the exploration phase (Tₑ) is a hyperparameter that can be set by a practitioner of the system 100. In some cases, the length of exploration phase is a function of the sparsity of an unknown parameter θ, which relates datapoint features to the difficulty of the expert task as described in further detail below. For instance, if the unknown parameter is sparser (that is, there are only datapoint features that describe difficulty) then the exploration phase is smaller. In some configurations, the number of exploration datapoints can be based on a budget (T) for the expert task. The budget reflects the total number of datapoints from the dataset for which the expert task will be performed. In some aspects, the number of datapoints for the exploration phase can be calculated as a sub-linear function of the total annotation budget such that the exploration subset scales well with an increasing budget. For instance, the number of datapoints in the exploration subset could be calculated as Tₑ=T^{2/3}. As an example to illustrate using that function, in the case of a budget of 1000 datapoints, the exploration phase would include 100 datapoints. This calculation ensures that the subset is large enough to provide meaningful insights while being manageable for the exploration phase.

In some aspects, the exploration component 110 selects datapoints for the exploration subset randomly. Alternatively, a more sophisticated approach can be used to ensure that the exploration subset is diverse and representative of the dataset. For instance, in some configurations, the exploration component 110 selects datapoints to maximize the minimum eigenvalue of the exploration subset. In such configurations, the exploration subset is constructed such that the minimum eigenvalue of the exploration subset is sufficiently large with high probability ensuring that the exploration datapoints are diverse. Mathematically, the approach can involve solving the following discrete optimization problem:

$$B = {arg min}_{{B}^{′} ⊆ A} {C}_{min} ( \frac{1}{\vert {B}^{′} \vert} {\sum }_{a ∈ {B}^{′}} {a}^{T} a ) \qquad ( 1 )$$

where B denotes the exploration subset, a denotes a particular datapoint, A denotes the sample set, and Cₘᵢₙ denotes minimum eigenvalue.

Note that each vector is a row vector in the above expression. However, due to computational intractability, a randomized rounding procedure can be used to obtain the exploration subset B. In some aspects, the randomized rounding procedure is a 2-step procedure. At a first step, the following relaxed convex optimization problem is solved using any standard convex optimization solver for a suitably chosen value of |B′|:

$$\hat{μ} = {arg min}_{μ ⊆ P ( A )} {C}_{min} ( {A}^{T} diag ( μ ) A ) \qquad ( 2 )$$

$$s . t . {‖ μ ‖}_{∞} \leq \frac{1}{\vert {B}^{′} \vert}$$

where P(A) denotes probability space over set A, diag denotes diagonal matrix, and ∥·∥_{∞} denotes the 1-infinity norm.

At a second step, using the obtained probability distribution, sample a is added to set B with probability |β′|\hat{μ}[a] for all remaining samples.

Using the exploration datapoints with their corresponding task difficulty scores from the exploration phrase, the difficulty model training component 112 of the model adaptation system 104 trains a difficulty prediction model to predict task difficulty scores for other datapoints in the dataset. In some configurations, a feature vector can be generated from each exploration datapoint for training the difficulty prediction model. The difficulty prediction model can be, for instance, a lightweight classifier, such as a sparse linear regression model, which can be trained efficiently with a small number of datapoints. This approach ensures that the difficulty prediction model can quickly and accurately estimate the difficulty of performing the expert task for other datapoints. By way of example only and not limitation, the difficulty prediction model can be a sparse linear regression-based estimator such as LASSO or Iterative Hard Thresholding. The estimation guarantees of these techniques often rely on strong sparsity conditions, but in theoretical results, similar estimation guarantees are provided even using weak sparsity conditions. In some aspects, if the task difficulty score is discretized, a classifier such as a logistic regression or support vector machine-based classifier can be used.

In some aspects, the task difficulty score (d) of an expert task for a datapoint can be captured by a feature vector a of the datapoint and an unknown parameter θ:

$$d = {a}^{T} \times θ \qquad ( 3 )$$

Given feature vectors of the exploration datapoints with their corresponding task difficulty scores, {(a₁, d₁), (a₂, d₂), . . . , a_{Te}, d_{Te})}, the difficulty model training component 112 learns an estimate 0 of the unknown parameter vector θ. One goal of the difficulty model training component 112 is to learn a difficulty prediction model that can generalize well to unseen datapoints, providing reliable task difficulty scores that guide the selection of further datapoints from the dataset for the expert tasks, as described in further detail below.

The difficulty scoring component 114 uses the trained difficulty prediction model provided by the difficulty model training component 112 to generate task difficulty scores for other datapoints in the dataset. The difficulty scoring component 114 applies the difficulty prediction model to other datapoints in the dataset (e.g., feature vectors of the datapoints), generating task difficulty scores for the datapoints that provide an indication of the difficulty of performing the expert task for each datapoint. These task difficulty scores facilitate prioritizing datapoints for the expert task, allowing for selection of the most informative and challenging datapoints.

The task component 116 utilizes the task difficulty scores from the difficulty scoring component 114 to facilitate selection of additional datapoints from the dataset in the dataset datastore 122 to send to an expert device, such as the expert device 102, for the expert to perform the expert task on those datapoints. This subsequent subset of datapoints selected from the dataset are referred to herein as a task subset with each datapoint being referred to herein as a task datapoint. The number of datapoints selected for the task subset can be based on a total budget for the expert task minus the number of datapoints in the exploration subset (T−Tₑ). For instance, given a budget of 1000 datapoints and an exploration subset of 100 datapoints, 900 datapoints would be selected for the task subset.

The task component 116 selects datapoints for the task subset based at least in part on the task difficulty scores generated by the difficulty scoring component 114. For instance, in some configurations, the task component 116 selects datapoints having the highest task difficulty scores. However, other approaches can be employed. The task component 116 ensures that task subset captures datapoints that are predicted to be the challenging and informative, thereby maximizing the benefit of the expert task when training a model. In some aspects, the selection process can balance data diversity and difficulty. By strategically selecting datapoints for the expert task, the task component 116 helps in improving the target model's performance and generalization capabilities. Additionally, the task component 116 ensures that the annotation budget is used effectively, focusing on datapoints that provide the most value in terms of learning and model improvement. This targeted approach to datapoint selection for the expert facilitates building robust and reliable machine learning models that can perform well on a wide range of tasks and data distributions.

The task datapoints are sent to the expert device 102 for the expert to perform the expert task, providing expert data for each datapoint, which can be stored in the expert data datastore 124. The expert data can comprise different data based on the expert task. For instance, in the context of an annotation task, the expert data can include a label for each unlabeled datapoint. In the context of an evaluation task, the expert data can comprise evaluation data based on the expert's evaluation of each input-output pair.

The expert interface component 118 serves as an interface between the model adaptation system 104 and expert devices, such as the expert device 102. The expert interface component 118 initially provides the exploration subset of datapoints to the expert device 102 for performance of the expert task. For instance, in the case in which the expert task is annotation, the expert interface component 118 provides unlabeled datapoints from the exploration subset to the expert device 102; while for model evaluation, the expert interface component 118 provides for each datapoint, for instance, the input to the target model paired with the target model's corresponding output. As the expert completes the expert task, the expert interface component 118 receives expert data generated by the expert (e.g., labels or evaluations). In instances in which the expert provides task difficulty scores for datapoints, the expert interface component 118 also receives the task difficulty scores. Upon selection of datapoints for the task subset, the expert interface component 118 provides the task subset of datapoints to the expert device 102 for performance of the expert task, and receives expert data generated by the expert for each task datapoint.

The expert data obtained for the exploration subset and the task subset can be used for model adaptation or evaluation of a target machine learning model. For instance, as shown in FIG. 1, the model adaptation system 104 comprises a model adaptation/evaluation component 120 that employs the expert data for model adaptation or evaluation. In the context of model adaptation, labeled datapoints can serve as high-quality supervision for training or fine-tuning a target model. Alternatively, annotated datapoints can be used for in-context learning, where the annotated datapoints serve as examples to guide a target model without requiring parameter updates. For evaluation, the evaluation data can act as a benchmark to assess the performance of an adapted model, ensuring that it aligns with expert judgment and meets task-specific criteria.

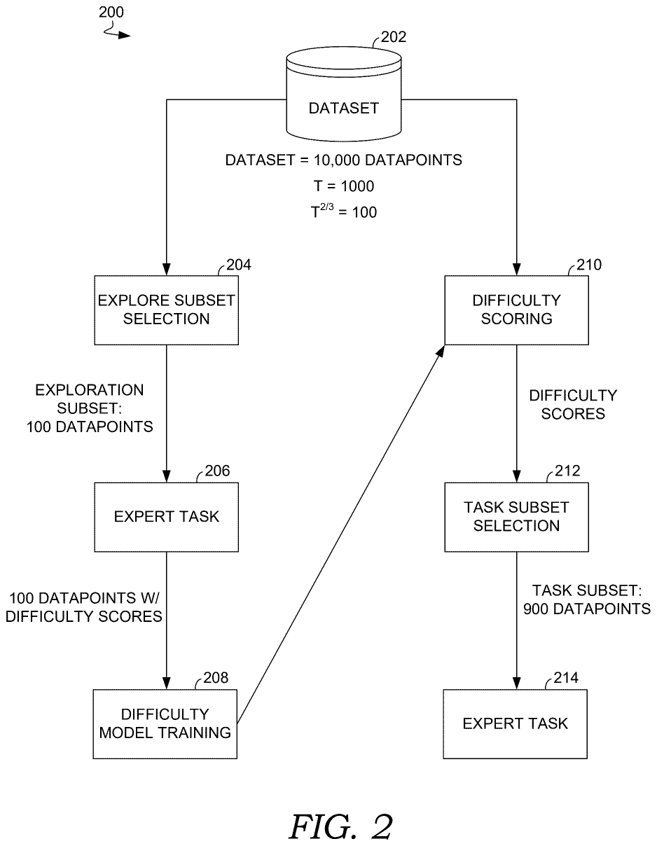

Turning next to FIG. 2, a block diagram is provided that illustrates a process 200 for facilitating an expert task on datapoints for model adaptation and/or evaluation. In this example, a dataset 202 stores 10,000 datapoints that can be employed for model training. Additionally, a budget T of 1000 datapoints for an expert task has been set, and 100 datapoints will be selected for the exploration phase.

As shown in FIG. 2, an explore subset selection 204 is performed to access 100 datapoints from the dataset 202 as an exploration subset for an exploration phase. In some aspects, the 100 datapoints are randomly sampled from the dataset 202. In other configurations, the datapoints are selected to provide a diverse subset of datapoints representative of the dataset 202. For instance, the datapoints can be selected to maximize the minimum eigenvalue of the exploration subset.

The 100 datapoints are provided to an expert for performing an expert task 206 for each datapoint. The expert task 206 provides expert data for each of the 100 datapoints, such as a label in the case of an annotation task or evaluation data in the case of an evaluation task. As part of the expert task, a task difficulty score is also obtained for each of the 100 datapoints. In some cases, the expert assigns task difficulty scores to datapoints based on the expert's assessment as to the level of difficulty for the expert to perform the expert task for each datapoint. In other cases, instead of relying of an expert's indication of difficulty, task difficulty scores are assigned to datapoints based on a proxy such as the time it took the expert to perform the expert task for each datapoint.

The 100 datapoints with their corresponding task difficulty scores are used to perform difficulty model training 208. In particular, a difficulty prediction model is trained using the 100 datapoints and their corresponding task difficulty scores. As previously discussed, in some aspects, this comprises using a feature vector of each datapoint pair with its corresponding task difficulty score to determine an unknown parameter θ. However, other approached can be employed to train a difficulty prediction model.

Using the trained difficulty prediction model, difficulty scoring 210 is performed to generate task difficulty scores for datapoints from the dataset 202. This can include generating a task difficulty score for each datapoint in the dataset 202 that was not included in the 100 datapoints selected for exploration. In this example, the 9,900 datapoints beyond the 100 datapoints selected for exploration are accessed from the dataset 202, and the trained difficulty prediction model generates a task difficulty score for each of those datapoints. The difficulty scoring 210 for a given datapoint can involve generating a feature vector of each datapoint and applying the trained difficulty prediction model to the feature vector to obtain the difficulty sore for that datapoint.

A task subset selection 212 is performed to select 900 datapoints from the dataset 202 based on the task difficulty scores to provide a task subset of datapoints. Since the budget for the expert task is 1000 datapoints and the exploration phrase involved performance of the expert task on 100 datapoints, 900 datapoints are selected for the task subset. In some aspects, the 900 datapoints having the highest task difficulty scores are selected.

The 900 datapoints in the task subset are provided to an expert for performing an expert task 214 for each of those datapoints. The expert task 214 provides expert data for each of the 900 datapoints, such as a label in the case of an annotation task or evaluation data in the case of an evaluation task. The expert data for the 100 datapoints in the exploration subset and the expert data for the 900 datapoints in the task subset are combined to provide expert data for 1000 datapoints (i.e., the budget set for the expert task).

In accordance with some further configurations of the present technology, datapoints can be selected for the expert task using a sparse linear bandits framework with the constraint that no arm can be pulled more than once (i.e., a blocking constraint). The following provides details regarding specific configurations of the presentation technology using a bandit setup as applied to an expert task labeling datapoints but can be applied to other expert tasks.

As a problem formulation and preliminaries, consider a dataset with a set of M unlabeled datapoints A≡{a⁽¹⁾, a⁽²⁾, . . . , a^{(M)}}⊆ [symbol] each of which will be referred to as an arm in the bandit setup. Let a^{(j)} denote the d-dimensional vector embedding associated with the j^{th} datapoint (arm). The arm embedding vectors are contained in a ball of radius R that is ∥a∥₂≤R∀a∈A.

Given an annotation budget of T rounds, in an annotation-poor regime, T<<d<<M; that is, the annotation budget is much smaller than the ambient dimension, which, in turn, is significantly smaller than the number of arms. At each round t∈[T], an unlabelled datapoint aₜ (corresponding to the arm which has not been pulled in the first t−1 rounds) is selected by an online algorithm (decision-maker) and sent to the expert annotator for labeling. Note that such a selection mechanism respects the blocking constraint, which stipulates that no unlabeled datapoint will be sent for annotation more than once. The expert labels the datapoint at and provides task difficult score rt that corresponds to the difficulty experienced in providing the ground truth label for at. If there are multiple experts, the expert data from the experts can be aggregated. The expected hardness [symbol] [symbol] θ, aₜ [symbol] at is modeled as a linear function of the arm embedding where θ∈ [symbol] is an unknown parameter vector. In particular, the random variable rt is obtained as rₜ=θ^{T} aₜ+nₜ where nₜ is zero-mean i.i.d noise random variable with bounded variance σ². More precisely:
1.

$$𝔼 [ {n}_{t} \vert {ℱ}_{t} ] = 0 and 𝔼 [ {n}_{t}^{2} \vert {ℱ}_{t} ] \leq {σ}^{2} , where {ℱ}_{t} = \{ ( {a}_{1} , {r}_{1} ) , … ( {a}_{( t - 1 )} , {r}_{( t - 1 )} ) \}$$

denotes the filtration till round t∈[T].
2. For any sparsity level k≤d the tail of the parameter vector θ is defined as,

$${β}_{k} := {‖ {θ}_{T \frac{c}{k}} ‖}_{1}$$

where [symbol] denotes the set of k largest coordinates of θ by absolute value and

$$𝒯 \frac{c}{k} = [ d ] ∖ {𝒯}_{k} .$$

Note that in the special case of k=0 for some sparsity level k<<d, 0 will be referred to as a hard-sparse vector. In some cases, soft sparsity is accounted for when the tail is non-zero and unknown—the statistical guarantees degrade gracefully as the tail magnitude increases. The following formally defines the objective (commonly known as regret) in an online learning set-up, which also respects the blocking constraint. The regret definition captures the difference in cumulative expected hardness of datapoints selected by the online algorithm versus the cumulative expected hardness of top T unique datapoints. Consider a permutation π:[|A|]→[|A|] of arms such that for any i<j, we have [symbol] θ, a^{(π(i))} [symbol] ≥ [symbol] (θ, a^{(π(i))} [symbol] . The regret Reg(T) for this setting is defined as:

$$Reg ( T ) := {\sum }_{t = 1}^{T} 〈 θ , {a}^{( π ( t ) )} 〉 - {\sum }_{t = 1}^{T} 〈 θ , {a}_{t} 〉 \qquad ( 4 )$$

Algorithm 1 below is designed to minimize expected regret E[Reg(T)] where the expectation is over the randomness in the algorithm.

Algorithm 1 Blocked Sparse Linear Bandits (BSLD) for Efficient Annotation

| 1: | Input: Unlabeled datapoints A, Annotation Budget T, Exploration Budget Tₑₓₚₗₒᵣₑ, | |
|---|---|---|
| | Regularization Parameter λ, Subset selection parameter ĝ | |
| 2: | [symbol] = GETGOODSUBSET(A, ĝ) | [symbol] Compute good subset of datapoints |
| | (arms) | |
| 3: | C = { }, [symbol] = { } | [symbol] Initialize Arm and Reward Set |
| 4: | for t ∈ [Tₑₓₚₗₒᵣₑ] do | |
| 5: | Sample randomly aₜ~ [symbol] and get task difficulty score rₜ | [symbol] Pull arm and get |
| | feedback | |
| 6: | C ← C ∪ {aₜ}, [symbol] ← [symbol] ∪ {rₜ} | [symbol] Store datapoint/arm and Task difficulty |
| | score | |
| 7: | [symbol] = [symbol] \ {aₜ} | [symbol] Update unlabeled good subset |
| 8: | end for | |
| 9: | \hat{θ} = arg min_{θ} \|\| θ \|\|₁ s. t. Σ_{t∈[T}_{ₑₓₚₗₒᵣₑ}_{]}( [symbol] [t] − [symbol] θ, C[t] [symbol] )_{²} ≤λ | [symbol] Compute estimate using |
| | LASSO | |
| 10: | [symbol] = A\C | [symbol] Datapoints (arms) available for exploit phase |
| 11: | for t ∈ [Tₑₓₚₗₒᵣₑ + 1, T] do | [symbol] Take Top-(T − Tₑₓₚₗₒᵣₑ) difficult |
| | samples | |
| 12: | aₜ = [symbol] \hat{θ}^{T}a | |
| 13: | C ← C ∪ {aₜ}, [symbol] = [symbol] \{aₜ} | |
| 14: | end for | |
| 15: | procedure GETGOODSUBSET(Set of Samples A, Subset selection parameter ĝ) | |
| 16: | Output: Sampled Subset [symbol] | |
| 17: | Maximize the objective function defined in (6) with input ĝ to obtain distribution \hat{μ} | |
| | over A. | |
| 18: | for j ∈ [M] do | |
| 19: | [symbol] = [symbol] ∪ {a^{(j)}} with probability ĝ \hat{μ}ⱼ | [symbol] Add sample j to [symbol] with |

| | |
|---|---|
| | prob. ĝ \hat{μ}ⱼ |
| 20: | end for |
| 21: | end procedure |

Algorithm 1 is an Explore-Then-Commit (ETC) algorithm referred to herein as Blocked Sparse Linear Bandits (BSLD). BSLB takes as input a set of unlabeled datapoints (arms) A, the annotation budget (time horizon) T, the exploration budget Tₑₓₚₗₒᵣₑ and Subset selection parameter ĝ. Steps 2-8 of BSLB correspond to the exploration component in the algorithm. In Step 2, a good subset of arms [symbol] ⊂A (using function GETGOODSUBSET(A, ĝ)) is computed that comprises representative arms that cover the d-dimensional space reasonably well. Subsequently, in Steps 4-8, arms are sampled without replacement from the set of arms [symbol] for Tₑₓₚₗₒᵣₑ rounds. The goal in the exploration component is to select a subset of arms such that the image of sparse vectors under the linear transformation by the gram matrix of the selected set has a sufficiently large magnitude (see Definition 1 below). Such a result ensures nice statistical guarantees of the parameter (difficulty) estimation with the subset labeled (with task difficulty scores) at the end of the exploration component. Since the set of arms, A can be arbitrary, note that sampling arms uniformly at random from the entire set might not have good coverage—especially when most arms are concentrated in a lower-dimensional subspace. Therefore, finding a good representative subset of arms leads to the following discrete optimization problem:

$${λ}_{min}^{*} := {max}_{{𝒢}^{′} ⊆ A} {λ}_{min} ( \vert {𝒢}^{′} \vert {\sum }_{a ∈ {𝒢}^{′}} a {a}^{T} ) \qquad ( 5 )$$

The function GETGOODSUBSET(A, ĝ) approximates the solution to this computationally infeasible discrete optimization. A relaxed concave program is maximized in Equation 10 (below) efficiently for a chosen input parameter ĝ to obtain a distribution \hat{μ} on the set of arms A—subsequently, the subset g is constructed using randomized rounding (Step 19) with \hat{μ} to obtain a feasible solution to Equation 5.

The second part of BSLB (Steps 9-14) corresponds to the exploitation component of the algorithm. In Step 9, the Lasso estimator is used to get an estimate 6 of the unknown parameter vector θ∈ [symbol] .

Note that the number of samples used in obtaining the estimate \hat{θ} is much smaller than the ambient dimension d. In Steps 11-14, datapoints are chosen that are predicted to be hard according to the recovered estimate \hat{θ}, and those datapoints are provided for annotation. At each round in BSLB, no arm is pulled more than once, thus respecting the blocking constraint. It should be noted that BSLB is two-shot. That is, the data acquisition strategy is changed only once after the exploration component—thus making the algorithm easy to use in practice.

The following provides a description of main theoretical results for this approach:

OFFLINE LASSO ESTIMATOR GUARANTEES WITH SOFT SPARSITY AND RE CONDITION: To the best of our knowledge, there do not exist in the literature offline guarantees for sparse linear regression that is (A) robust to sparsity modeling assumption and (B) holds only under the mild RE condition on the Gram matrix. A first theoretical result fills this gap to a certain extent with an upper bound on error rate. Initially, the definition of Restricted Eigenvalue (RE) is provided as:
Definition 1. Restricted Eigenvalue (RE): X∈ [symbol] satisfies Restricted Eigenvalue property RE(k₀,γ,X), if there exists a constant K(k₀,γ,X) such that for all z∈ [symbol] and z≠0,

$$0 < K ( {k}_{0} , γ , X ) = {min}_{J ⊆ \{ 1 , … , d \} \vert J \vert \leq {k}_{0}} {min}_{{‖ {z}_{J c} ‖}_{1} \leq γ {‖ {z}_{J} ‖}_{1}} \frac{{\vert Xz ‖}_{2}}{{‖ {z}_{J} ‖}_{2}} \qquad ( 6 )$$

It has been shown that RE is among the weakest conditions imposed in the literature on the Gram matrix to ensure nice statistical guarantees on the Lasso estimator for sparse linear regression.

Theorem 1. Let X∈ [symbol] be the data matrix with n samples, dimension d. Let r∈ [symbol] be the corresponding observations such that r=Xθ+n, where n∈ [symbol] is a zero-mean random vector with i.i.d. components having bounded variance σ²=O(1). Suppose X satisfies restricted eigenvalue property (Def. 1) with RE

$$( k , 4 ( 1 + {γ}_{1} ) , \frac{X}{\sqrt{n}} )$$

with constant K. Let θ have a tail βₖ at sparsity level k that is,

$${β}_{k} := {‖ {θ}_{T \frac{c}{k}} ‖}_{1} \leq {γ}_{2} {‖ {θ}_{{T}_{k}} ‖}_{1}$$

for some γ₂∈ [symbol] satisfying γ₂≤γ₁, where [symbol] is the set of k largest coordinates by absolute value. An estimate \hat{θ} of θ recovered using Lasso (Line 9 in BSLB), satisfies following with probability 1−exp(−Ω(n)):

$${‖ θ - \hat{θ} ‖}_{2} = \tilde{O} ( {n}^{- 1 / 2} {k}^{1 / 2} {K}^{- 2} + {k}^{- 1 / 2} {β}_{k} + {n}^{- 1 / 4} {β}_{k}^{1 / 2} {K}^{- 1} ) \qquad ( 7 )$$

Insight 1. Note that in Equation 7, for a fixed sparsity k, the estimator error guarantee decays with datapoints n and RE constant K while growing linearly with the tail βₖ. Existing error guarantees in literature focus only on hard sparse θ—the data matrix X satisfies

$$RE ( k , 3 , \frac{X}{\sqrt{n}} )$$

with constant K′ and γ₂=0. However, with moderately stronger assumption of

$$RE ( k , 6 , \frac{X}{\sqrt{n}} )$$

on the data matrix, guarantees of Theorem 1 hold for all γ₂<½. As stated in Theorem 1, for a larger tail with γ₂>½, X needs to satisfy RE on a larger cone of vectors.

Remark 1. Note that the statistical guarantee presented in Theorem 1 is an offline error rate that is robust to sparsity modeling assumption. However, the former holds only for the special case when X has i.i.d. Gaussian rows, and the latter requires the stronger RIP condition on the data matrix. The error guarantee here is much more general and holds for deterministic data matrices X satisfying RE.

The following derives a corollary for the case when the rows of the design matrix are sampled without replacement from a set whose empirical covariance matrix has a minimum eigenvalue.

Corollary 1. Let X∈ [symbol] be the data matrix with n samples and dimension d, whose rows are sampled uniformly without replacement from a set [symbol] ⊂ [symbol] . Let

$$Λ = {λ}_{min} ( {\vert 𝒢 \vert}^{- 1} {\sum }_{a ∈ 𝒢} a {a}^{T} ) .$$

Consider the same setup for observations r as in Theorem 1. Provided n=Ω(kΛ⁻⁴), an estimate \hat{θ} of θ recovered using Lasso (Line 9 in BSLB), will satisfy with probability 1−exp(−Ω(n)):

$${‖ θ - \hat{θ} ‖}_{2} \leq \tilde{O} ( {n}^{- 1 / 2} {k}^{1 / 2} {Λ}^{- 1} + {k}^{- 1 / 2} {β}_{k} + {n}^{- 1 / 4} {β}_{k}^{1 / 2} {Λ}^{- 1 / 2} ) \qquad ( 8 )$$

Note in particular that we do not have the (γ₂≤γ₁) assumption on the parameter vector θ in Corollary 1. Instead, it is replaced by a lower bound on n—datapoints sampled without replacement from the set [symbol] whose gram matrix has a sufficiently large minimum eigenvalue. This is possible because a lower bound on minimum eigenvalue for a positive semi-definite matrix implies a lower bound on RE with arbitrary parameters—concentration guarantees imply that the RE condition remains satisfied when sufficient (yet smaller than | [symbol] |) number of datapoints are sampled from

[symbol]

ONLINE GUARANTEES—REGRET BOUND FOR BSLB: The next result is the expected regret incurred by BSLB in the online setting. The key ingredient in the regret analysis lies in appropriately accounting for the blocking constraint in the exploitation component of BSLB. Below presents the result detailing the regret guarantees of BSLB when the exploration period Tₑₓₚₗₒᵣₑ is set optimally using a known sparsity level k. Corollary 1 is invoked at the end of the exploration component to obtain error guarantees of Lasso, which in turn bounds the maximum regret incurred in each step of the exploitation component. The exploration/exploitation trade-off are optimized to obtain the stated result.

Theorem 2. (Regret Analysis of BSLB) Consider the d-dimensional sparse linear bandits framework with blocking constraint having a set A⊂B^{d} of M arms spanning [symbol] and T rounds (T<<d<<M). In each round t∈[T], the process chooses arm aₜ∈A and observes reward rₜ=<θ, aₜ>+nₜ where θ∈ [symbol] is unknown and nₜ is zero-mean independent noise random variable with variance σ²=O(1). Suppose θ has tail magnitude

$${β}_{k} := {‖ {θ}_{T \frac{c}{k}} ‖}_{1}$$

at sparsity level k where Tₖ ⊆{1, . . . , d} is the set of k largest coordinates by absolute value. Let λₘᵢₙ* for the set A be as defined in Equation 5 and assume that λₘᵢₙ*=Ω(log² M). In this framework, BSLB with exploration period

$${T}_{explore} = \tilde{O} ( {k}^{\frac{1}{3}} {T}^{\frac{1}{3}} ) ,$$

achieves a regret guarantee:

$$𝔼 [ REG ( T ) ] = \tilde{O} ( {{k}^{\frac{1}{3}} ( {λ}_{min}^{*} )}^{- 1} {T}^{\frac{2}{3}} + {k}^{- \frac{1}{2}} {β}_{k} + {{k}^{- \frac{1}{12}} ( {λ}_{min}^{*} )}^{- 1 / 2} {β}_{k}^{\frac{1}{2}} {T}^{\frac{5}{6}} ) \qquad ( 9 )$$

Insight 2. BSLB enables diversity in selected arms by performing Step 2 in algorithm 1—this step ensures that λₘᵢₙ of the covariance matrix of the subset used in exploration is approximately optimal. The exploration period in Theorem 2 is optimized to maximize annotation of hard samples. However, in practice, the exploration period of BSLB can be increased further if diversity has more importance.

Insight 3. The runtime of the GETGOODSUBSET(A, ĝ) and the optimization in Step 9 of BSLB (LASSO) is Poly(M, d, T). However, if the mild assumption λₘᵢₙ*(log² M) not satisfied, then GETGOODSUBSET(A, ĝ) can be replaced with a (modified) Brute Force Algorithm that runs in time O(M^{d}), and the theorem statement still holds. Note that the stated runtime in the latter part is still significantly lower than the trivial brute force search for the optimal subset having a runtime of O(exp(M)). This is possible because, as a result of the approximation guarantees of Theorem 3, the size of the subset can be restricted while performing a brute-force search.

SUBSET SELECTION FOR MAXIMIZING THE MINIMUM EIGENVALUE: Recall that Step 5 of BSLB involves sampling from a carefully chosen subset of arms that has good coverage—more precisely, our goal is to solve the optimization problem in Equation 5 to obtain a representative set of arms. Due to the blocking constraint, the process identifies a subset of representative arms from which to sample uniformly at random without replacement in the exploration component—this leads to the objective in Equation 5 being discrete and therefore non-convex. Note that a brute force solution to the objective implies a search over all subsets of [M] and will take time Q(exp(M)). To design an efficient algorithm for obtaining a good feasible solution to the non-convex objective in 2, a first step is to obtain a convex relaxation as described in Equation 10—in particular, instead of optimizing over a subset, the process optimizes over probability distributions over the set of arms such that the probability mass over any arm is bounded from above:

$$\hat{μ} ( \hat{g} ) = arg {max}_{μϵ P ( A )} {λ}_{min} ( A diag ( μ ) {A}^{T} ) such that {‖ μ ‖}_{∞} \leq \frac{1}{\hat{g}} \qquad ( 10 )$$

Note that A=[a¹, . . . , a^{M}]^{T}∈ [symbol] denotes the matrix with all arms and ĝ is an additional parameter to the relaxed objective. Since the solution to Equation 10 might not be a feasible one for Equation 5, a randomized rounding (Step 19 in BSLB) procedure is used to obtain a feasible solution. In the randomized rounding procedure, each datapoint j∈[M] is sampled into a feasible output set [symbol] (used in the exploration component) independently with probability ĝμⱼ.

Let X⊆A with g*=|X| be the optimal subset for which the RHS in Equation 5 is maximized and let λₘᵢₙ* in be the corresponding objective value (minimum eigenvalue). The following presents a theorem on the approximation guarantees of the solution achieved by the procedure GetGoodSubset of Algorithm 1—the theorem says that the minimum eigenvalue of the gram matrix associated with datapoints in [symbol] (obtained post randomized rounding procedure) is close to λₘᵢₙ*.

Theorem 3. Let A=[a¹, . . . , a^{M}]^{T}∈ [symbol] denote the matrix of all arms. Consider the convex optimization of Equation 10 solved at ĝ=O(d). Let g be the output of the randomized rounding procedure (Step 18-20 of algorithm 1) and \hat{λ} min be the minimum eigenvalue of the corresponding covariance matrix that is,

$$\hat{λ} min = {λ}_{min} ( \vert {𝒢}^{- 1} \vert {\sum }_{a ∈ 𝒢} a {a}^{T} ) .$$

Then under the assumption λₘᵢₙ*=Ω((log² M)²), this provides λₘᵢₙ*≤2\hat{λ}ₘᵢₙ (log M)² with probability 1−o(1).

If assumption of λₘᵢₙ*=Ω((log² M)²) is not satisfied in its place, then the process can implement a brute-force search over all subsets whose size is in the range [d,αd](for some constant α>1) to maximize the objective in Equation 5—note that the time complexity is still polynomial in the number of arms M^{O(d)}, which is significantly improved than the trivial brute force algorithm which has a running time of O(exp M). Note that the modified brute-force algorithm enjoys stronger approximation guarantees, with

$$\frac{{λ}_{min}^{*}}{2} \leq {\hat{λ}}_{min}$$

and has a running time that is still polynomial in the number of arms M but exponential in the dimension d.

Remark 2. Note that several existing techniques in experimental design deal with maximizing objectives such as minimum eigenvalue; however, the existing work assumes submodularity or matroid constraints, which the average minimum eigenvalue (normalized with size of the set) in this setting does not satisfy.

Proof Outline: It is first shown in Lemma 4 (using concentration guarantees) that the following two objective values are close, namely (A) value of the maximized concave objective with distribution \hat{μ}∈P(A) and parameter ĝ in Equation 10 (B) objective value of the set G (Equation 5) obtained via randomized rounding procedure from \hat{μ} at ĝ (line 19 in BSLB). Note that the value of the maximized concave objective in Equation 10 with parameter g₁ is larger than the value with parameter g₂ provided g₁<g₂. Therefore, it is shown the approximation guarantees with respect to objective in Equation 10 with parameter d—which in turn also translates into guarantees for the optimal parameter g* even though g* is unknown (since g*≥d). Finally, given that the concave objective with parameter d in Equation 10 is a relaxation of the discrete objective in Equation 5, the objective value of the former is going to be larger than the objective value of the latter. Combining all these key ingredients, we have proved our theorem statement.

CORRALLING WHEN OPTIMAL SPARSITY LEVEL IS NOT KNOWN: Note that for any unknown parameter vector θ, the sparsity level k can be fixed and therefore the corresponding tail magnitude βₖ—subsequently, the guarantees of Theorem 2 can be obtained by setting the exploration period optimally for the fixed k. However, if k is set too low, then βₖ will be too high, and therefore, the second term in regret (Equation 9) dominates. On the other hand, if k is set too high, then βₖ is low but the first term in the regret bound dominates. There is a trade-off, and therefore, there is an optimal choice of sparsity k* and, tail magnitude βₖ*. Therefore, a meta-algorithm C-BSLB is proposed that exploits corralling multiple versions of the BSLB algorithm 1 with different values of k used to set the exploration period Tₑₓₚₗₒᵣₑ—the meta-algorithm gradually learns to choose the best base algorithm. However, naively applying CORRAL with all distinct base algorithms leads to a linear dependence on dimension d in the regret making it vacuous. Therefore, a carefully chosen log d base algorithms is used for search within CORRAL with corresponding sparsity parameters set on exponentially spaced points—such a restriction ensures that the overhead in regret is minimal (logarithmic dependence on dimension d). However, the regret guarantee is proven with respect to the base algorithm with optimal sparsity—although it is not guaranteed that the optimal base algorithm will be in the set of carefully chosen base algorithms provided as input to the meta-algorithm.

Theorem 4. Consider the d-dimensional sparse linear bandits framework with blocking constraint as described in Theorem 2. Let the C-BSLB algorithm run with an appropriate learning rate on multiple versions of BSLB, using distinct sparsity parameter k taking values in the set

$${\{ {2}^{i} \}}_{i = 0}^{⌊ {log}_{2} ( d ) ⌋ + 1} .$$

Let the optimal sparsity parameter in Theorem 2 that achieves minimum regret be k* ∈{1,2, . . . , d−1, d}, and let E[Reg(T)]_{*} be the corresponding regret. Then the meta-algorithm C-BSLB achieves the following regret guarantee:

$$𝔼 [ Reg ( T ) ] = O ( \sqrt{T {log}_{2} ( d )} + \sqrt{{k}^{*}} {log}_{2} ( d ) {𝔼 [ Reg ( T ) ]}_{*} ) \qquad ( 11 )$$

Note that the first term in Equation 11 and the multiplicative factor of \sqrt{k}*log₂(d) corresponds to the additional cost in combining the input base algorithms by the C-BSLB algorithm. It should be noted that the dependence on dimension d from the additional cost is only logarithmic.

### Example Methods for Enhanced Data Sampling for Expert Tasks

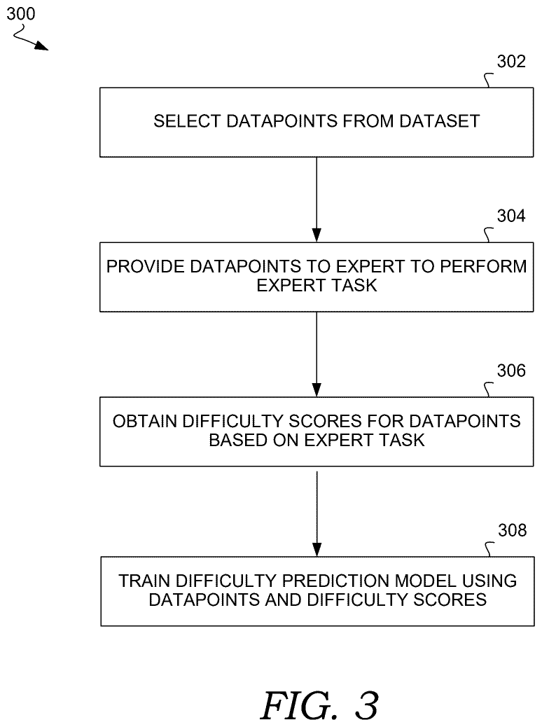

With reference now to FIG. 3, a flow diagram is provided that illustrates a method 300 for performing an exploration phase to obtain task difficulty scores for an exploration subset and employing the task difficulty scores to train a difficulty prediction model in accordance with some aspects of the technology described herein. The method 300 can be performed, for instance, by the model adaptation system 104 of FIG. 1. Each block of the method 300 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 302, datapoints are selected from a dataset comprising a plurality of datapoints as part of an exploration phase to provide an exploration subset. In some aspects, the datapoints are randomly sampled. In other aspects, the datapoints are sampled to ensure diversity and representativeness of the dataset. For instance, an initial subset can be constructed by selecting datapoints in order to maximize a minimum eigenvalue of the initial subset, and the exploration subset can be sampled from this initial subset, or the initial subset can comprise the exploration subset.

Once the exploration subset is selected, the datapoints in the exploration subset are communicated over a network to a user device of an expert, as shown at block 304. The expert performs an expert task on these datapoints, such as annotation or evaluation, providing expert data for each datapoint that can be used for model adaptation or evaluation of a target machine learning model. Additionally, as shown at block 306, based on the expert performing the expert task, task difficulty scores are obtained for each datapoint in the exploration subset. The task difficulty scores indicate the difficulty experienced by the expert in performing the expert task for each datapoint. The task difficulty scores can be assigned directly by the expert or determined using a proxy, such as the time taken to complete the expert task for each datapoint.

As shown at block 308, a difficulty prediction model is trained using the exploration subset and the corresponding task difficulty scores. The difficulty prediction model is designed to predict task difficulty scores for other datapoints in the dataset that were not included in the exploration subset. The difficulty prediction model can be, for instance, a lightweight classifier, such as a sparse linear regression model, which can be trained efficiently with a small number of datapoints.

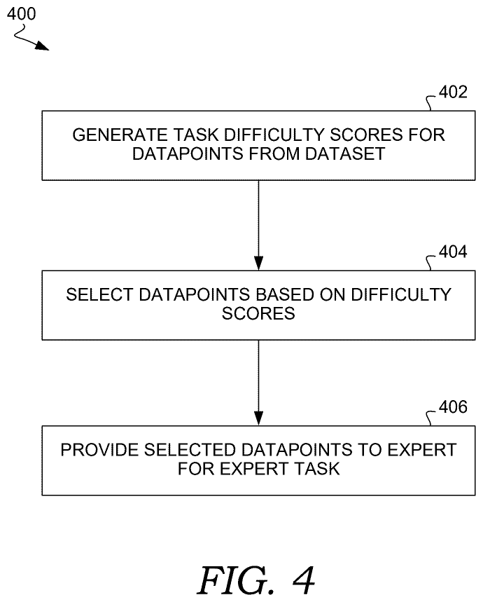

Turning next to FIG. 4, a flow diagram is provided that illustrates a method 400 for using a trained difficulty prediction model to determine task difficulty scores for datapoints in a dataset and using the task difficulty scores to select a task subset of datapoints for an expert task. The method 400 can be performed, for instance, by the model adaptation system 104 of FIG. 1.

As shown at block 402, task difficulty scores are generated for datapoints from a dataset using a trained difficulty prediction model (e.g., obtained via the method 300 of FIG. 3). This can involve applying the trained difficulty prediction model to the datapoints that were not included in an exploration subset used in training the difficulty prediction model. Once the task difficulty scores are generated, a task subset of datapoints are selected from the dataset based on the task difficulty score scores, as shown at block 404. For instance, this could involve selecting datapoints with the highest difficulty scores.

The task subset of datapoints is then communicated over a network to a user device of an expert, as shown at block 406. The expert performs the expert task on these datapoints, such as annotation or evaluation, providing expert data for each datapoint. This expert data for the task subset of datapoints can be used in conjunction with expert data for the exploration subset of datapoints for model adaptation or evaluation of a target machine learning model.

### Exemplary Operating Environment

Having described implementations of the present disclosure, an exemplary operating environment in which embodiments of the present technology can be implemented is described below in order to provide a general context for various aspects of the present disclosure. Referring initially to FIG. 5 in particular, an exemplary operating environment for implementing embodiments of the present technology is shown and designated generally as computing device 500. Computing device 500 is but one example of a suitable computing environment and is not intended to suggest any limitation as to the scope of use or functionality of the technology. Neither should the computing device 500 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 5, computing device 500 includes bus 510 that directly or indirectly couples the following devices: memory 512, one or more processors 514, one or more presentation components 516, input/output (I/O) ports 518, input/output components 520, and illustrative power supply 522. Bus 510 represents what can be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 5 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer storage media in the form of volatile and/or nonvolatile memory. The memory can be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which can be built in. Illustrative components include a microphone, joystick, game pad, satellite dish, scanner, printer, wireless device, etc. The I/O components 520 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 500. The computing device 500 can be equipped with depth cameras, such as, stereoscopic camera systems, infrared camera systems, RGB camera systems, and combinations of these for gesture detection and recognition. Additionally, the computing device 500 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
sampling a first subset of datapoints from a dataset comprising a plurality of datapoints;
communicating the first subset of datapoints over a network to a user device of an expert for performance of an expert task for model adaptation or evaluation of a target machine learning model;
accessing task difficulty scores for the first subset of datapoints, each task difficulty score for the first subset of datapoints being indicative of a difficulty for the expert in performing the expert task for each datapoint in the first subset of datapoints;
training a difficulty prediction model using the first subset of datapoints and the task difficulty scores for the first subset of datapoints;
generating, using the difficulty prediction model, task difficulty scores for other datapoints from the dataset not in the first subset of datapoints;
sampling a second subset of datapoints from the other datapoints based on the task difficulty scores for the other datapoints; and
communicating the second subset of datapoints over a network to the user device of the expert for performance of the expert task.

2. The one or more computer storage media of claim 1, wherein the operations further comprise:
receiving, from the user device over the network, expert data for the first subset of datapoints;
receiving, from the user device over the network, expert data for the second subset of datapoints; and
employing the expert data for the first subset of datapoints and the expert data for the second subset of datapoints for model adaptation or evaluation of the target machine learning model.

3. The one or more computer storage media of claim 1, wherein the first subset of datapoints are randomly sampled from the dataset.

4. The one or more computer storage media of claim 1, wherein the first subset of datapoints are sampled from the dataset by:
generating an initial subset of datapoints from the dataset to maximize a minimum eigenvalue of the initial subset of datapoints; and
sampling the first subset of datapoints from the initial subset of datapoints.

5. The one or more computer storage media of claim 1, wherein accessing the task difficulty scores for the first subset of datapoints comprises:
receiving the task difficulty scores for the first subset of datapoints from the user device of the expert, wherein the task difficulty scores are assigned to the first subset of datapoints by the expert.

6. The one or more computer storage media of claim 1, wherein accessing the task difficulty scores for the first subset of datapoints comprises:
receiving, from the user device of the expert, time data for the first subset of datapoints, the time data comprising data indicative of an amount of time for the expert to perform the expert task for each datapoint in the first subset of datapoints; and
determining the task difficulty scores for the first subset of datapoints using the time data.

7. The one or more computer storage media of claim 1, wherein a number of datapoints in the second subset of datapoints is based on a total budget of datapoints for the expert task and a number of datapoints in the first subset of datapoints.

8. The one or more computer storage media of claim 7, wherein the number of datapoints in the first subset of datapoints is determined as a sub-linear function of the total budget of datapoints for the expert task.

9. The one or more computer storage media of claim 1, wherein selecting the second subset of datapoints from the other datapoints based on the task difficulty scores for the other datapoints comprises:
selecting datapoints having highest task difficulty scores for the second subset of datapoints.

10. The one or more computer storage media of claim 1, wherein the plurality of datapoints comprise unlabeled data and the expert task comprises an annotation task providing a set of labeled datapoints based on the first subset of datapoints and the second subset of datapoints; and wherein the set of labeled datapoints are used for model adaptation of the target machine learning model.

11. The one or more computer storage media of claim 1, wherein the plurality of datapoints comprise input-output data pairs from the target machine learning model and the expert task comprises an evaluation task providing evaluation data; and wherein the evaluation data is used to evaluate performance of the target machine learning model.

12. A computer-implemented method comprising:
obtaining, by an exploration component of a model adaptation system, task difficulty scores for an exploration subset of datapoints sampled from a dataset comprising a plurality of datapoints for model adaptation or evaluation of a target machine learning model;
training a difficulty prediction model using the exploration subset of datapoints and the task difficulty scores for the exploration subset of datapoints;
generating, using the difficulty prediction model, task difficulty scores for other datapoints from the dataset not in the exploration subset of datapoints;
selecting, by a task component, a task subset of datapoints from the other datapoints based on the task difficulty scores for the other datapoints; and
communicating, by an expert interface component, the task subset of datapoints to a user device of an expert to perform an expert task for each datapoint in the task subset of datapoints.

13. The computer-implemented method of claim 12, wherein the method further comprises:
receiving, from the user device over a network, expert data for the exploration subset of datapoints;
receiving, from the user device over the network, expert data for the task subset of datapoints; and
employing the expert data for the exploration subset of datapoints and the expert data for the task subset of datapoints for model adaptation or evaluation of the target machine learning model.

14. The computer-implemented method of claim 12, wherein the method further comprises:
randomly sampling, by the exploration component, the exploration subset of datapoints from the dataset.

15. The computer-implemented method of claim 12, wherein the method further comprises sampling, by the exploration component, the exploration subset of datapoints from the dataset by:
generating an initial subset of datapoints from the dataset to maximize a minimum eigenvalue of the initial subset of datapoints; and
sampling the exploration subset of datapoints from the initial subset of datapoints.

16. The computer-implemented method of claim 12, wherein the task difficulty scores are assigned to the exploration subset of datapoints by the expert.

17. The computer-implemented method of claim 12, wherein the task difficulty scores are assigned to the exploration subset of datapoints based on time data indicative of an amount of time for the expert to perform the expert task for each datapoint in the exploration subset of datapoints.

18. The computer-implemented method of claim 12, wherein a number of datapoints in the exploration subset of datapoints is based on a total budget of datapoints for the expert task and a number of datapoints in the exploration subset of datapoints, and wherein the number of datapoints in the exploration subset of datapoints is determined as a sub-linear function of the total budget of datapoints for the expert task.

19. A computer system comprising:
a data storage device storing a dataset comprising a plurality of datapoints; and
a model adaptation system comprising one or more processors, and one or more computer storage media storing computer-useable instructions that, when used by the one or more processors, causes the computer system to perform operations comprising:
sampling datapoints from the dataset to provide an exploration subset of datapoints;
communicating the exploration subset of datapoints over a network to a user device of an expert for performance of an expert task for model adaptation or evaluation of a target machine learning model;
receiving, for the user device, task difficulty scores for the exploration subset of datapoints, each task difficulty score being assigned by the expert to a datapoint from the exploration subset of datapoints;
training a difficulty prediction model using the exploration subset of datapoints and the task difficulty scores for the exploration subset of datapoints;
generating, using the difficulty prediction model, task difficulty scores for other datapoints from the dataset not in the exploration subset of datapoints;
sampling datapoints from the other datapoints based on the task difficulty scores for the other datapoints to provide a task subset of datapoints;
communicating the task subset of datapoints over a network to the user device of the expert for performance of the expert task;
receiving expert data from the user device of the expert for the exploration subset of datapoints and the task subset of datapoints; and
adapting or evaluation a target machine learning module using the expert data.

20. The computer system of claim 19, wherein the exploration subset of datapoints are sampled from the dataset by:
generating an initial subset of datapoints from the dataset to maximize a minimum eigenvalue of the initial subset of datapoints; and
sampling the exploration subset of datapoints from the initial subset of datapoints.
